(19) United States
(12) Patent Application Publication
(10) Pub. No.: US 2008/0240983 A1
(43) Pub. Date: Oct. 2, 2008

(54) Modular assay reader system and apparatus

(75) Inventor: Paul C. Harris, Bothell, WA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Response Biomedical Corporation, Burnaby (CA)

(21) Appl. No.: 12/077,529

(22) Filed: Mar. 19, 2008

Related U.S. Application Data
(60) Provisional application No. 60/920,726, filed on Mar. 29, 2007.

(51) Int. Cl. G01N 21/76; B01J 19/00; G01N 27/00; G01N 31/00; G01N 21/64

(52) U.S. Cl. 422/52; 422/68.1; 422/82.08; 422/82.02; 702/23

(57) ABSTRACT

A modular reader system and method provides for testing a test sample and determining characteristics of the sample. A first test module is configured to perform a first reading on a test sample and produce data regarding the reading. A second test module is configured to perform a second reading of the test sample and produce data regarding the second reading. The first and second test modules are communicatively coupled to a control module. The control module collects the data produced by the first and second test modules and processes the data to determine characteristics of the test sample.

### RELATED APPLICATION

This application claims the benefit of U.S. Provisional Application No. 60/920,726, filed on Mar. 29, 2007. The entire teachings of the above application are incorporated herein by reference.

### BACKGROUND OF THE INVENTION

Quantitative analysis of cells and analytes in fluid samples, particularly bodily fluid samples, often provides critical diagnostic and treatment information for physicians and patients. Quantitative immunoassays utilize the specificity of the antigen (Ag)-antibody (Ab) reaction to detect and quantitate the amount of an Ag or Ab in a sample. In solid phase immunoassays, for example, one reagent (e.g., the Ag or Ab) is attached to a solid surface, facilitating separation of bound reagents or analytes from free reagents or analytes. The solid phase is exposed to a sample containing the analyte, which binds to its Ag or Ab; the extent of this binding is quantitated to provide a measure of the analyte concentration in the sample.

Immunoassay readers enable such quantitative analysis of fluid samples by detecting and measuring the extent of antigen-antibody binding in a sample. Immunoassays based on fluorescence utilize a fluorescently labeled solid phase. An immunoassay reader employing a fluorescence analyzer may therefore measure the quantity of an antibody or antigen by optically scanning and detecting fluorescent emissions of the solid phase following contact of the sample containing the analyte with the solid phase. By measuring the level of fluorescence, the immunoassay reader provides quantitative analysis of analyte concentration of a fluid sample.

### SUMMARY OF THE INVENTION

In some procedures, testing a fluid sample may require analyzing the fluid sample for the presence of more than one substance. Such a procedure typically involves preparing multiple test samples of the fluid, each test sample corresponding to a substance to be detected. Due to the nature of detecting particular substances, more than one type of assay reader may be required, e.g., readers providing one of fluorescence detection, optical absorption sensing, electrochemical sensing, oxygen sensing, conductivity sensing, and chemiluminescent detection. The test samples may then be analyzed individually by one or more readers, and the resulting scan data is processed and presented by each of the readers. Thus, a typical test for detecting multiple different substances may require separate analysis and processing by multiple readers. A user must therefore collect the scan data from each of the utilized readers to obtain complete results of the test.

Embodiments of the present invention provide a modular reader system and related method for analyzing a test sample and determining characteristics of the sample. A test sample may be divided into a plurality of portions (e.g., a first portion and a second portion) for preparation for different tests or in multiple test cartridges, where a portion of the test sample is used in each test. In a particular embodiment, a system includes a first test module configured to perform a first reading on a first portion of a test sample and produce data regarding the reading. A second test module is configured to perform a second reading on a second portion of the test sample and produce data regarding the second reading. The first and second test modules are communicatively coupled to a control module. The control module collects the data produced by the first and second test modules and processes the data to determine characteristics of the test sample.

In further embodiments, a control module comprises a test parameter interface, such as a touch screen and lot card reader, that enables a user to input test parameters for one or more readings to perform on a test sample. The control module utilizes control circuitry to communicate, via a test module interface, with one or more test modules to configure and initiate readings to perform on the test sample. Upon receiving processed test data from the test modules, processing circuitry at the control module further processes the test data to determine characteristics of the test sample, which are provided as a resulting data set.

In still further embodiments of the present invention, a test module includes at least one channel port for receiving a test sample, as well as an optical reader for scanning a received test sample at the channel port. The reader communicates, via an interface, with a control module to receive scanning parameters. Based on the received scan parameters, the test module performs a scan of the test sample and a processor processes the scan results to produce scan data. The test module further transmits the processed scan data to the control module for further processing, thereby determining characteristics of the test sample.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a diagram of an example modular reader system of the present invention.

FIG. 2 is a flow chart of an example method of reading a test sample.

FIG. 3 is a block diagram of an example control module.

FIG. 4 is a block diagram of one channel an example test module.

FIG. 5 is a diagram of an example software control program operated by a control module.

### DETAILED DESCRIPTION OF THE INVENTION

A description of example embodiments of the invention follows.

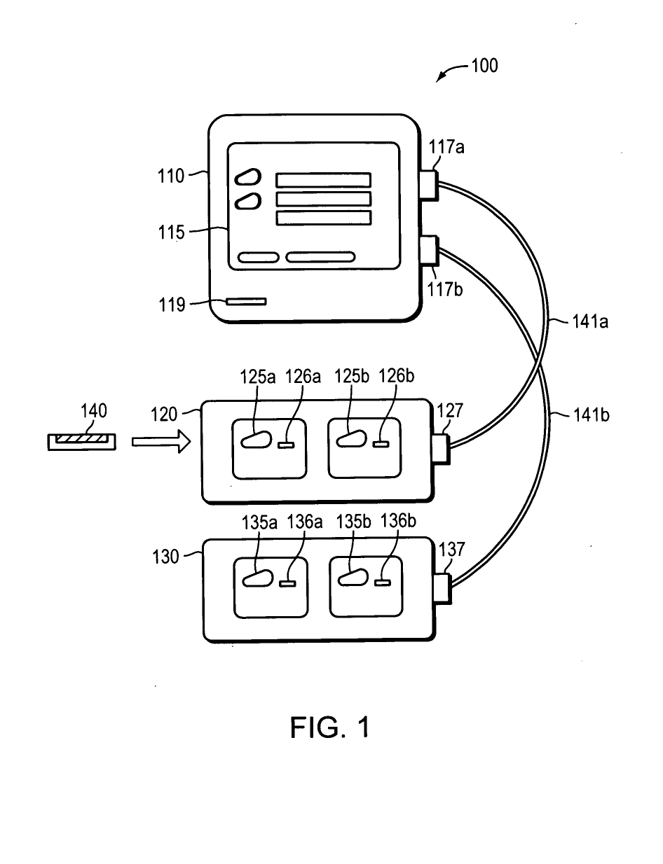

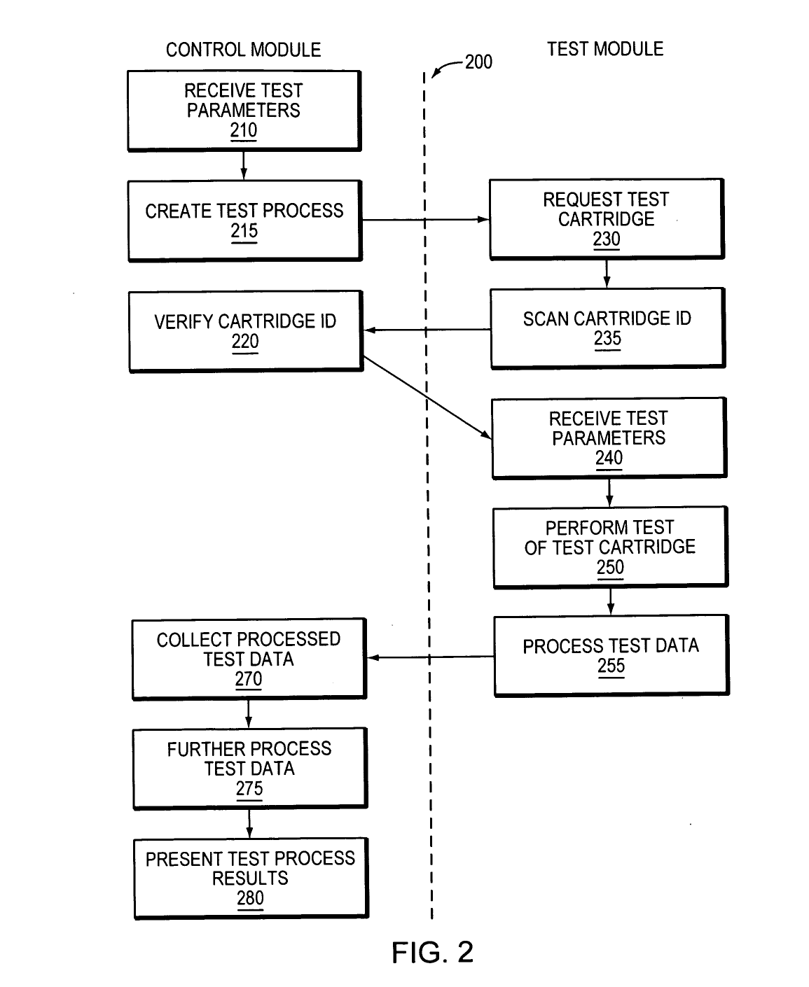

FIG. 1 illustrates an example modular reader system 100 of the present invention. The system 100 includes a control module 110 and two test modules 120, 130. The control module 110 includes, as external components, a touch screen 115 (having a display with a tactile input overlay), lot reader channel 119, and module interfaces 117a-b. The control module 110 is coupled to each of the test modules 120, 130 by way of respective serial line cables 141a-b connected between module interfaces 127, 137 and the module interfaces 117a-b at the control module 110. The serial line cables 141a-b represent a bus or signal path through which the control module 110 and test modules 120, 130 may communicate. Alternatively, such a bus or signal path may be enabled by parallel transmission lines or wireless communications channels between the control module 110 and test modules 120, 130. In additional embodiments, additional test modules (not shown) may be coupled to the control module.

The test modules 120, 130 in the embodiment illustrated each include two separate channels for conducting a test of a test sample. Other embodiments may have one or more than two channels. Each channel is represented, at the front face of a test module 120, 130, by a port 125a-b, 135a-b that accepts a test cartridge 140 containing substance of the test sample to be analyzed. Located next to each port 125a-b, 135a-b is a respective LED light 126a-b, 136a-b that may provide a visual indication to a user during various stages of a test process, such as a channel status indicator and a prompt for user action (e.g., to insert a test cartridge). Thus, the test modules 120, 130 may accept a test sample, such as a sample contained in the test cartridge 140, into one or more ports 125a-b, 135a-b, conduct a test of the test sample (e.g., conduct a scan of the test sample), and transmit data regarding the test to the control module 110. The control module may collect this test data and further process the data, alone or in conjunction with data regarding additional tests, to provide characteristics of the test sample. These characteristics may be presented to a user visually through the touch screen 115, or may be transmitted to a peripheral or other device for storage, printing or further processing.

In particular embodiments, the test modules 120, 130 may be configured to perform tests of the same or different types, or may be configured with the same or different test parameters. Such configuration may be determined by communications from the control module 110, software or firmware programming, or available instruments at each channel. For example, each channel of the test modules 120, 130 may have instruments of one or more of a fluorescence detector, optical absorption sensor, electrochemical sensor, oxygen sensor, conductivity sensor, chemiluminescent detector, and other testing or analysis utilities. A particular channel of the test modules 120, 130, upon receiving a test sample through a respective port 125a-b, 135a-b, may therefore analyze the test sample using instruments available at that channel. The test may be further defined by parameters communicated from the control module 110, such as parameters determining frequency, length or timing of the test, as well as target constituent substances for detection. The control module 110 may further communicate with the test modules 120, 130, responsive to user commands, to initiate and run a series of tests of a test sample, collect data from the series of tests, and further process the data to present characteristics of the test sample.

FIG. 2 is a flow chart illustrating a process 200 of initiating and running a test of a test sample. The process 200 may be performed, for example, by the modular reader system 100 of FIG. 1, and in particular by a control module 110 in communication with a test module 120. With reference to FIG. 1, a control module 110 receives test parameters regarding a test to be conducted (210). Test parameters generally relate to information utilized by the control module 110 and test modules 120, 130 to perform a test of the test sample, including software instructions, configuration data and identifiers. The test parameters may be entered by reading a lot card (not shown) inserted into to the lot reader channel 119. The control module 110 may, for example, read the lot card to receive software instructions regarding a particular test to be performed on a corresponding test cartridge containing the test sample. The control module 110 may receive further configuration information, such as a sample ID and user ID, from the user via the touch screen 115. Software instructions or configuration data may also be stored at the control module 110 or an external device (not shown), where it may be retrieved by the control module 110. Alternatively, the control module 110 may receive test parameters by scanning a barcode, communicating with a radio-frequency identification (RFID) device, or downloading the parameters from a Universal Serial Bus (USB) device, a computer or a server across a network (not shown).

In response to the received test parameters, the control module 110 creates a test process (215). Such a test process includes instructions to be completed by the control module 110 and one or more test modules 120, 130 in order to conduct the subject test. The instructions may include selection and configuration for one or more test modules 120, 130; instructions directing the test modules 120, 130 to test the test sample, process test data and transmit the test data; and instructions directing to control module 110 to further process the test data and present results of the test.

Upon creating the test process, the control module 110 may transmit relevant instructions and test parameters to each of the test modules 120, 130 to be utilized in the test. The control module 110 transmits instructions to at least one such test module 120 to request a test cartridge. The test module may request the test cartridge by flashing an LED 126a-b or providing some other visual or audio indication to the user to insert a cartridge into a respective channel (230). The control module 110 may provide further instruction for inserting the cartridge through the touch screen. Upon receiving the cartridge, the test module tests the cartridge to retrieve its cartridge ID, which is a value identifying one or more of the cartridge, the lot including the test cartridge, and the test to be performed. The cartridge ID may be indicated by a bar code printed on the test cartridge or by a radio-frequency identification (RFID) tag in the cartridge, which is scanned by a bar code reader or RFID reader at the test module 120. The test module 120 then transmits the cartridge ID to the control module 110, which verifies the cartridge ID to ensure that the correct test cartridge was inserted (220). If an incorrect test cartridge was inserted (e.g., the cartridge does not match a test of the test process or was inserted into a different channel or test module than required), then the control module 110 displays an error message and instructions for the user to remove the test cartridge. If the correct test cartridge was inserted into the required channel, the control module transmits relevant instructions and test parameters to the test module 120 to be utilized in the test.

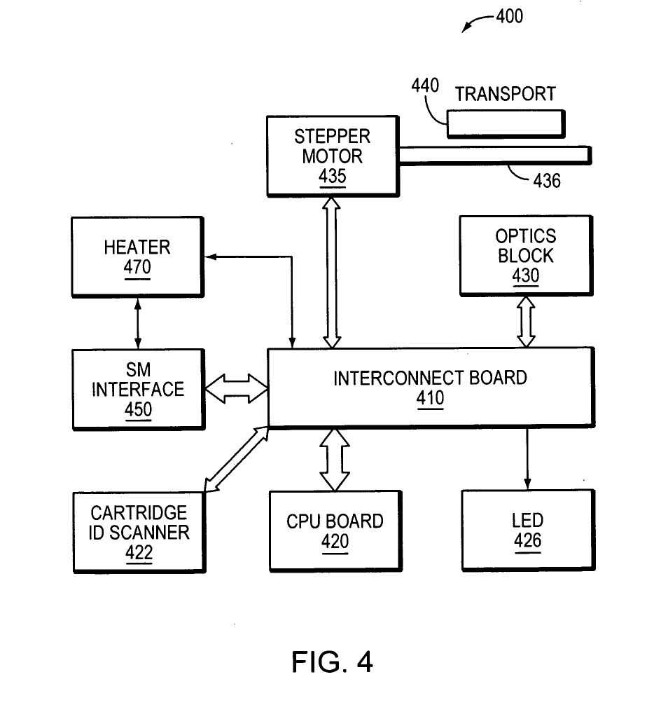

The test module 120 receives the instructions and test parameters (240), and configures a test according to those parameters. The test module 120 then initiates a test of the test sample (250). The test process performed by the test module 120 may be dependent on a number of factors such as the properties of the testing instrument(s) employed, the received test parameters and the type of test performed. An example embodiment of a test module and test process is described in further detail below with reference to FIG. 4.

During the test of the test sample (250), the test module 120 generates initial test data (e.g., numeric values corresponding to optical readings provided by the scanning instrument or other analysis tool). The test data is then processed according to the test parameters, for example by calculating quantities pertinent for analysis (255). The test module 120 then transmits the processed test data to the control module 110, where it is collected to a register or data store (270). If a test process indicates that one or more additional scans are to be completed, the aforementioned process at the test module 120 may be repeated under the test parameters defining those additional scans. Further, an additional test may be completed simultaneously with the first test by employing an additional channel of the test module, or by initiating the test at a second test module (e.g., test module 130). The additional test may require an additional cartridge (not shown) containing the test sample, and the additional cartridge may further be prepared in a different manner in accordance with the additional test.

The control module 110 further processes the collected test data according to the configured test process (275). Such processing may include, for example, performing additional calculations on the test data to determine characteristics of the test sample (e.g., the presence and quantity of detected substance in the test sample). These characteristics may then be presented, via the touch screen 115 or other output, as test results (280). Moreover, the processing and presenting may entail further operations according to the test process. For example, the control module 110 may receive test data from more than one test module or channel, representing the results of multiple tests. The control module 110 may utilize this plurality of test data, in conjunction, to perform calculations on the plurality of test data. As a result, the control module 110 may present a quantitative or qualitative feature of the test sample that is derived from multiple tests across different modules or channels. The feature may be presented, along with other test results, as a unified data set for display on the touch screen 115 or output to an external device for printing, data storage or further processing.

In a particular example of a test process, a user may design a test process to determine levels of high-density lipoproteins (HDL), low-density lipoprotein (LDL) and glucose of a test sample. The user prepares first and second cartridges containing the test sample, where the first cartridge is prepared for detecting lipoproteins and the second cartridge is prepared for detecting glucose. The user enters test parameters for the test process by inserting one or more lot cards into the control module 110 and configuring the test via the touch screen (210). The test parameters also include identifiers for the first and second cartridge, which may be indicated by a bar code or RFID tag at each cartridge and entered into the control module with a bar code reader (not shown) or an RFID reader (not shown).

In accordance with the test parameters, the control module 110 creates a corresponding test process and, in doing so, locates a first test module 120 that is equipped to scan the test sample to detect lipoproteins, as well as a second test module 130 that is equipped to scan the test sample to detect glucose. The test process therefore includes instructions directed to both a first and second test module 120, 130, and the control module 110 transmits respective test parameters to both test modules 120, 130 (240). Thus, the first test module 120 receives test parameters to detect lipoproteins, and the second test module 130 receives test parameters to detect glucose. The control module 110 also instructs the test modules 120, 130 to initiate the respective scans according to the test process.

The first test module 120 requests the first cartridge by flashing an LED corresponding to one of its channels (245). It may be further equipped with a device to correctly identify the first cartridge, such as a bar code reader or RFID reader to correctly identify the first cartridge. Upon detecting the first cartridge, the first test module 120 initiates a scan of the test sample. Prior to scanning, if the test parameters indicate that the sample is to be scanned at a defined temperature, then the test module 120 utilizes a heater and temperature sensor to heat the cartridge to the defined temperature. When the defined temperature is detected, first test module performs a scan of the test sample to detect lipoproteins. In scanning, the test module transports the first cartridge in a linear direction relative to an optics block (described below with reference to FIG. 4). The optics block directs a light into the cartridge and detects resulting light. The first test module 120 generates test scan data (255), which are numeric values corresponding to the detected light.

The second test module 130 follows substantially the same procedure as that of the first test module 120, but instead scans the second cartridge under test parameters to detect glucose. Because the second test module 130 operates independently of the first 120, the control module 110 can instruct the second test module 130 to scan simultaneously with the first test module 120.

Processed test data from both test modules 120, 130 is collected by the control module 110 (270). The control module 110 then further processes the test data to determine the levels of HDL, LDL and glucose in the test sample (275). These values are included in the test process results that are presented by the control module 110 at the touch screen 115 (280) or are transmitted to an external module for storage, printing or further processing. Moreover, the control module 110 can perform additional calculations involving a combination of the determined HDL, LDL and glucose. For example, the control module 110 may perform a calculation to assess a risk of cardiovascular disease, for which HDL, LDL and glucose levels are factors. Thus, a processor at the control module 110 may enter the calculated HDL, LDL and glucose levels into one or more mathematical formulas, and compare the output with a series of thresholds. Based on this comparison, the control module 110 may present, along with the calculated HDL, LDL and glucose values, an indication estimating a risk of cardiovascular disease. This indication may also be accompanied by related quantitative values for further analysis, thereby presenting qualitative and quantitative features of the test sample based on the determined HDL, LDL and glucose.

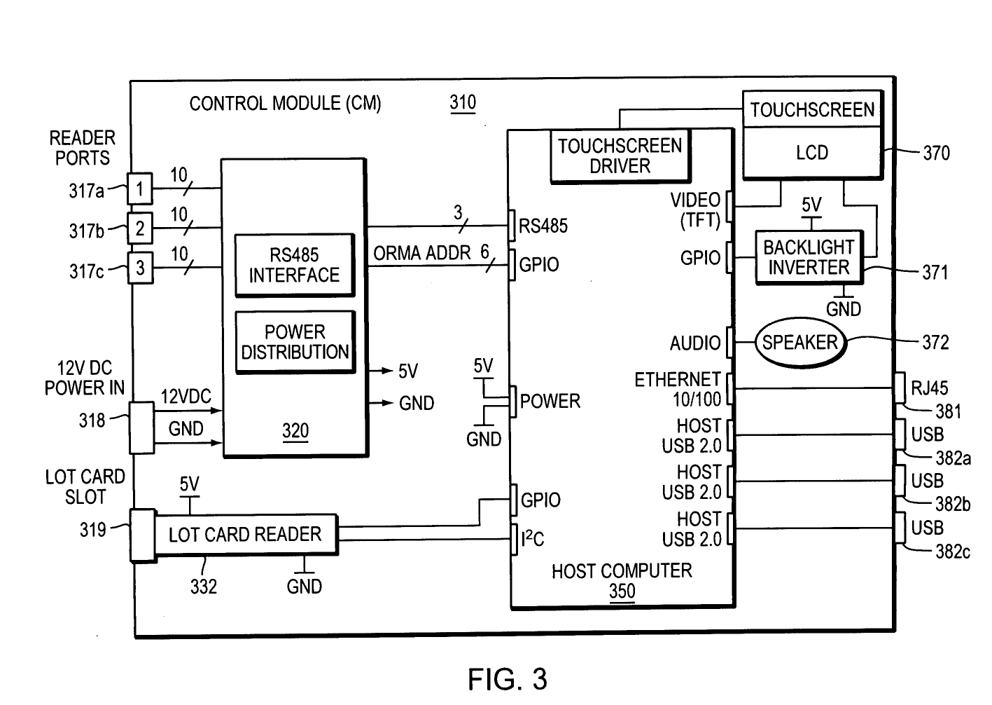

FIG. 3 is a block diagram of an example control module 310, illustrating particularly the constituent circuit components. The control module 310 includes a host computer 350, which includes a central processing unit (CPU), memory and a number of device drivers and corresponding interfaces as shown. Among these interfaces is a USB driver for external communications via three USB ports 382a-c; an Ethernet driver for communicating via an Ethernet port 381; a speaker driver for operating a speaker 372; a general purpose I/O (GPIO) for driving a backlight inverter 371; video and touch screen drivers for operating an LCD touch screen 370; interfaces to communicate with the lot card reader 332 and reader interface 320; and a DC power input.

The reader interface 320 enables communications between the host computer 350 and one or more test modules (e.g., test modules 120, 130) via the test module ports 317a-c. Alternatively or additionally, the reader interface may utilize wireless transmission, via an antenna and transceiver (not shown), to enable communications with the one or more test modules. The reader interface 320 also includes power distribution circuitry for receiving DC power at the power input port 318.

The lot card reader 332 is adapted to receive a lot card (not shown) at the lot card slot 319. A lot card may contain software instructions to be utilized by the control module 310 to create a test process, including instructions establishing test parameters, processing and presenting test data, and structuring the test. The lot card reader 332 retrieves these instructions from the received lot card and transmits them to the host computer 350 for creating the test process.

Based on the received lot card instructions and user input at the touch screen 370, the host computer may create a test process to initiate one or more tests of a test sample, collect the test data from associated test modules, process the test data to determine characteristics of the test sample (e.g., presence or absence of a particular substance), and present the characteristics of the test sample. The test process may include additional or alternative functions, such as connecting with a peripheral or other device through the Ethernet port 381 or USB ports 382 to upload, print or store results, or further processing to calculate a quantitative or qualitative feature of the test sample, e.g., as described above with reference to FIG. 2.

From the created test process, the host computer transmits, through the reader interface 320, test parameters to each of the associated modules to be utilized, and may further command the test modules to initiate the respective tests. The control module 310 may also provide instructions to a user, displayed at the touch screen 370, to conduct the test, such as instructions to insert a cartridge into a test module port as required by the test.

Following a completed test by a test module, the reader interface 320 receives the respective test data from the test module, and in turn transmits the test data to the host computer 350. The test data may include numeric values directly corresponding to the test, or may be values resulting from processing at the test module. The test data may be processed at the host computer 350 to determine characteristics of the test sample. The host computer 350 may further combine the characteristics with results from additional tests completed by the same or other test modules, providing a unified data set incorporating a plurality of characteristics of the test sample. Moreover, the host computer 350 may further process the test data or determined characteristics in one or more operations described above with reference to FIG. 2.

FIG. 4 is a block diagram of one channel 400 of an example test module. A test module, such as the test module 120 of FIG. 1, may include the channel 400 circuitry, as illustrated in FIG. 4, in one or more of its channels for receiving and analyzing a test sample. One or more components of the channel 400, such as the external interface 450 and CPU board 420, may be shared by one or more additional channels of a test module. The channel 400 includes an external interface 450 through which the channel 400 communicate with a control module, such as the control module 110 of FIG. 1. The interface 450 may enable communications with the control module by a serial or other cable (e.g., cable 141a) connected to an external port of the test module, or through a wireless transceiver and antenna (not shown) for wireless communications.

The control module transmits test parameters to the channel 400 through the interface 450, which are forwarded to the interconnect board 410 and further to the CPU board 420. In accordance with those test parameters, the channel 400, as controlled by the CPU board 420, performs a number of operations to request and detect the test sample, perform a test of the test sample, generate test data, and transmit the test data to the control module for collection. Examples of these and additional operations are described above with reference to FIG. 2.

In one example of a test process, the channel indicates to a user to insert a cartridge containing the test sample by flashing an external LED light 426. Once the cartridge is detected to be inserted into the channel port, the cartridge ID scanner 422 scans the inserted cartridge to acquire its cartridge ID, which is then transmitted to the control module to verify that the correct cartridge is inserted. The cartridge ID scanner 422 may include a bar code reader, RFID reader or other device to read the cartridge ID. If the correct cartridge is inserted, the control module transmits relevant scan parameters to the test module channel 400, which the CPU board 420 utilizes to set up a test of the cartridge. The heater block 470 senses the temperature of the block 470 and provides and indication of this temperature. If the test parameters indicate a particular temperature at which to test the cartridge, then the heater block 470 heats the cartridge to that required temperature. The heater block 470 may also provide an indication that the heater block is active, or feedback of the block temperature, directly to the control module via the external interface 450.

The inserted cartridge is received to the cartridge transport 440, the movement of which is controlled by a stepper motor 435 turning a screw drive 436. By rotating the screw drive 436, the stepper motor may incrementally move the cartridge transport 436 in a direction parallel to the screw drive 436. A cartridge (not shown) containing a test sample may be inserted into a respective port of the channel 400 and fixed to the cartridge transport 440.

During a test, the cartridge is transported across the field of view of an optics block 430, enabling the optics block to scan the length of the cartridge where the test sample is present. The LED light 426 may turn on to indicate that the scan is in process. In one example embodiment, where the reader channel 400 performs a scan for an immunoassay based on fluorescence, the optics block 430 emits a shorter wavelength light into the cartridge at the transport 440, and collects longer wavelength light emitted by the test sample in a fluorescent reaction. Analog signals corresponding to the collected light are transmitted to the interconnect board 410, where an analog-to-digital converter converts the analog signals to digital values. The digital values are further forwarded to the CPU board 420, which processes the values to generate scan data. As described above, the scan data may include numeric values corresponding to the readings produced by the optics block during the scan. The CPU board transmits the processed scan data, via the external interface 450, to the control module for further processing. Thus, the reader channel 400 performs a scan of the test sample and generates scan data, which may be collected and processed by a control module to determine characteristics of the test sample.

The optics block 430, stepper motor 435, screw drive 436 and transport 440 are utilized by the channel 400 to perform an optical scan of a test sample. Alternatively, other equipment suitable for performing other types of analysis of a test sample (e.g., electrochemical sensing, oxygen sensing, or conductivity sensing) may be implemented in the channel 400.

By performing the various operations of a test process across one or more test modules and a control module, embodiments of the present invention utilize instrumentation in a consolidated, efficient manner. Moreover, the modularity of the present invention enables a user to initiate multiple and diverse tests using a single interface, and collect, process and present results of those test from a single interface. As a further result, the test results from multiple modules can be integrated and used, in conjunction, to determine additional quantitative and qualitative features of the test sample.

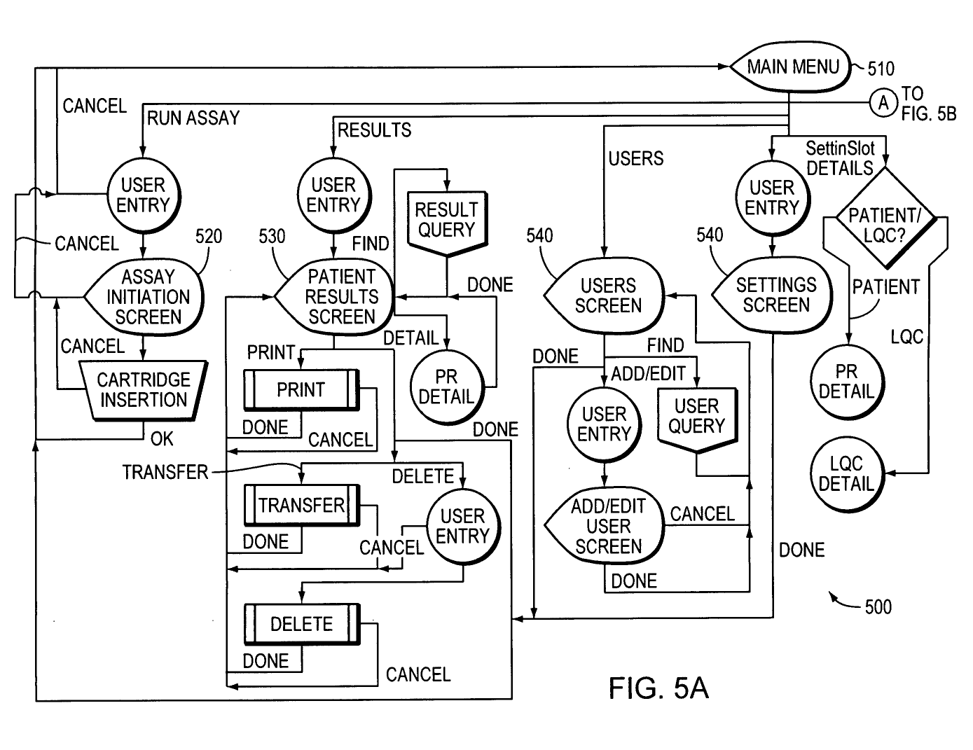

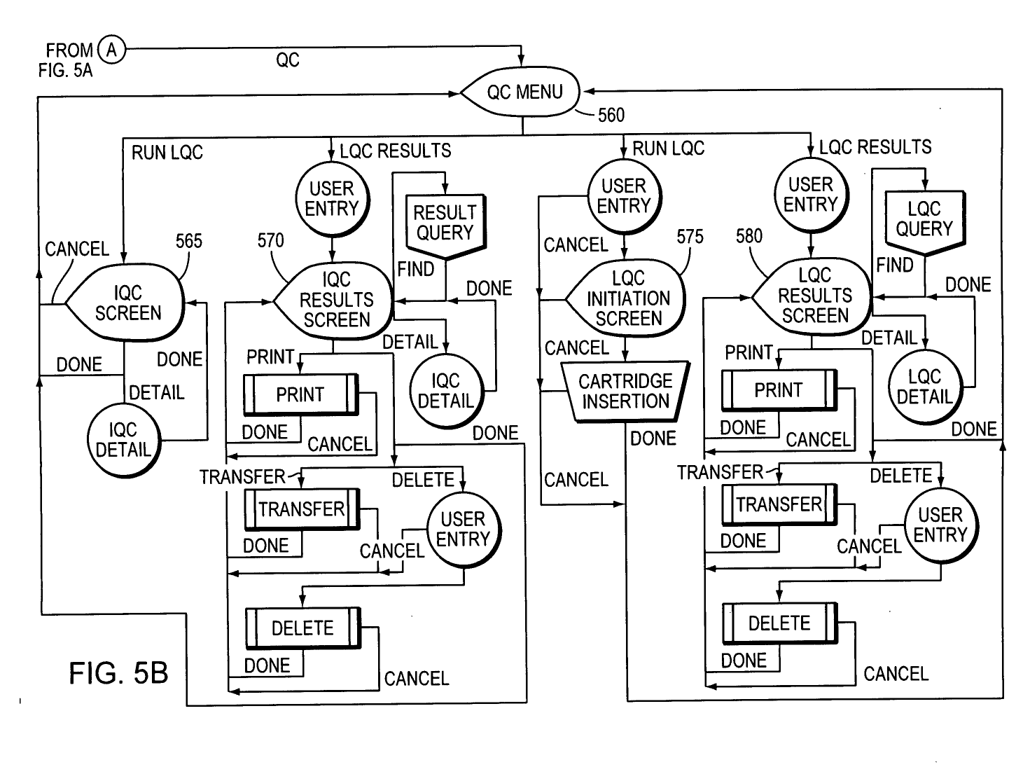

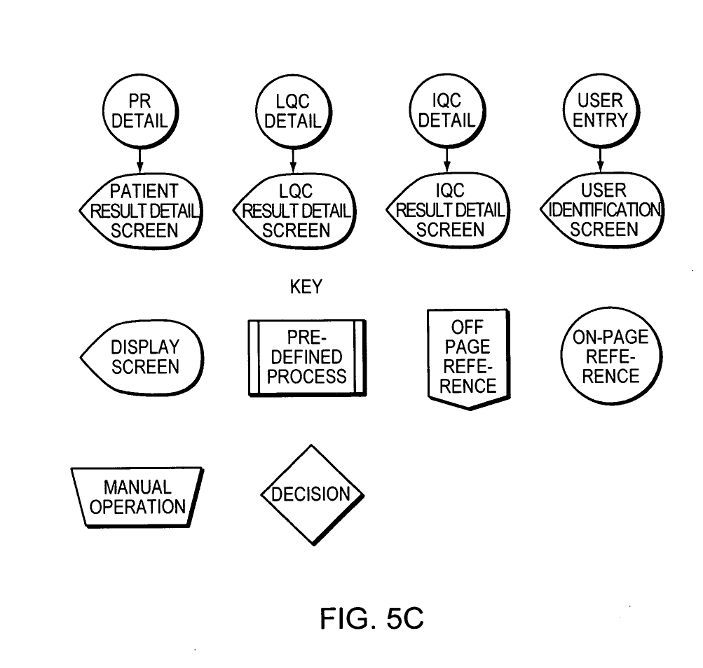

FIG. 5 is a diagram of a software control program 500 utilized by a control module in example embodiments of the present invention. The program may be utilized by the control modules 110, 310 of FIGS. 1 and 3. Through a display screen, such as the touch screens 110, 370, the program 500 provides a series of menus through which a user can interface to set up, configure and initiate a test of a test sample. From a main menu 510, the program 500 provides, by user selection or other processes, a number of submenus, including an assay initiation screen 520, results screen 530, users screen 540, settings screen 550 and quality control (QC) screen 560.

Preceding the assay initiation screen 520, the user may insert a lot card and enter additional information to create a test process. From the assay initiation screen 520, a user may initiate the test of a test sample, including inserting the cartridge containing the test sample into a channel of a test module.

Following a test of a test sample and processing of the test data, the results screen 530 enables a user to view the test process results and stored results from previous processes. The user may print the test process results, transfer them to an external device for storage or further processing, or delete the results.

From a users screen 540, a user can view, add or edit user information. The user may view and edit additional settings, such as a sample identifier (ID), through the settings screen 530.

The quality control (QC) menu 560 enables a user to view and edit entries in one or more sets of quality control data. The quality control data may include stored results from previous test processes, as well as preconfigured data for comparison with present test process results. The QC menu 560 links to an internal quality control (ICQ) screen 565 and ICQ results screen 570, through which a user may view, edit, transfer, print and delete ICQ data.

A liquid quality control (LCQ) initialization screen 575 enables a user to initiate a test of a test sample, the results of which are entered into the LQC results. From the LQC results screen 580, a user may view, edit, print, transfer or delete results stored as LCQ results.

The program 500 as illustrated in FIG. 5 includes a number of states and processes associated with a user interface. The program 500 may further include additional processes related to the states and processes shown. In particular, the program 500 can include processes associated with a test process as described above with reference to FIGS. 2 and 3. For example, in response to a user command at the assay initiation screen 520, the program 500 can run a corresponding test process by initiating one or more readings of a test sample; collect data indicating results of the one or more readings; calculating, from the data, quantitative values corresponding to characteristics of the test sample; and presenting those quantitative values, e.g., by way of a results screen 530. The program may provide further instructions according to the test process to further process the data of one or more readings to produce qualitative or quantitative features of the test sample.

While this invention has been particularly shown and described with references to example embodiments thereof, it will be understood by those skilled in the art that various changes in form and details may be made therein without departing from the scope of the invention encompassed by the appended claims.

What is claimed is:

1. A modular reader system for determining characteristics of a test sample, comprising:
a first test module configured to perform a first reading on a first portion of a test sample and produce first data relating to the first reading;
a second test module configured to perform a second reading on a second portion of the test sample and produce second data relating to the second reading;
a control module configured to collect the first and second data and process the first and second data to determine characteristics of the test sample.

2. The system of claim 1, wherein the second reading is distinct from the first reading by at least one of a substance to be detected and method of detection.

3. The system of claim 1, wherein the control module calculates a qualitative or quantitative feature of the test sample, the feature corresponding to the first and second data.

4. The system of claim 1, wherein the control module controls the first and second readers to initiate the first and second readings.

5. The system of claim 1, wherein one of the first and second test modules includes a fluorescence detector and performs a fluorescence immunoassay.

6. The system of claim 5, wherein the other of the first and second test modules includes at least one of an optical absorption sensor, electrochemical sensor, oxygen sensor, conductivity sensor, and chemiluminescent detector.

7. The system of claim 5, wherein the other of the first and second test modules includes a fluorescence detector and performs a fluorescence immunoassay.

8. The system of claim 1, further comprising a system bus configured to carry the first and second data from the first and second test modules to the control module, the system bus including at least one of a serial transmission line and a wireless communications channel.

9. A method of determining characteristics of a test sample, comprising:
initiating a first reading of a first portion of a test sample;
initiating a second reading of a second portion of a test sample;
collecting data indicating results of the first and second readings;
calculating, from the data, quantitative values corresponding to presence of at least one substance in the test sample; and
providing a data set including the quantitative values.

10. The method of claim 9, further comprising calculating a quantitative or qualitative feature of the test sample, the feature corresponding to data of the first and second readings.

11. The method of claim 9, wherein the second reading is distinct from the first reading by at least one of a substance to be detected and method of detection.

12. A control module for providing characteristics of a test sample, comprising:
a test parameter interface for defining test parameters relating to readings to perform on a test sample;
a test module interface for communicating with a plurality of test modules;
control circuitry that, responsive to the test parameters, controls the plurality of test modules via the test module interface to test the test sample and transmit data regarding the test to the control module; and
processing circuitry that processes the data to provide a resulting data set, the data set relating to the transmitted data from each of the control modules and indicating characteristics of the test sample.

13. The control module of claim 12, wherein the test parameter interface is configured to receive the test parameters from at least one of a barcode, a radio-frequency identification (RFID) device, a Universal Serial Bus (USB) device, a computer, and a server across a network.

14. The control module of claim 12, wherein the test parameter interface includes a lot card reader.

15. A test module for determining characteristics of a test sample, comprising:
a channel port for receiving a test sample;
a reader for testing a test sample at the channel port;
an interface to communicate with a control module;
a processor that processes results of the test to produce test sample data, the processor transmitting the test sample data via the interface to a control module for further processing, the further processing determining characteristics of the test sample.

16. The test module of claim 15, wherein the further processing includes associating the test sample data with data from at least one other test module.

17. The test module of claim 15, further comprising a second channel port for receiving the test sample.

18. The test module of claim 15, further comprising a heater to heat the test sample to a configured temperature.

19. The test module of claim 15, wherein the optical reader includes a fluorescence detector and the testing includes a fluorescence immunoassay.

20. The test module of claim 15, wherein the optical reader includes at least one of an optical absorption sensor, electrochemical sensor, oxygen sensor, conductivity sensor, and chemiluminescent detector.

21. The test module of claim 15, further comprising a visual indicator to indicate to a user to insert the test sample into the channel port.

22. A modular reader system for determining characteristics of a test sample, comprising:
a plurality of test modules configured to perform a respective plurality of readings on a test sample and produce data relating to the respective plurality of readings; and
a control module configured to collect the data and process the data to determine characteristics of the test sample.

23. The system of claim 22, wherein at least one of the plurality of test modules includes a fluorescence detector and performs a fluorescence immunoassay.
